(19) United States
(12) Patent Application Publication
(10) Pub. No.: US 2015/0032449 A1
(43) Pub. Date: Jan. 29, 2015

(54) Method and Apparatus for Using Convolutional Neural Networks in Speech Recognition

(71) Applicant: Nuance Communications, Inc., Burlington, MA (US)

(72) Inventors: Tara N. Sainath, Yorktown Heights, NY (US); Abdel-Rahman S. Mohamed, Yorktown Heights, NY (US); Brian E. D. Kingsbury, Yorktown Heights, NY (US); Bhuvana Ramabhadran, Yorktown Heights, NY (US)

(73) Assignee: Nuance Communications, Inc., Burlington, MA (US)

(21) Appl. No.: 13/952,455

(22) Filed: Jul. 26, 2013

(51) Int. Cl. G10L 15/26

(52) U.S. Cl. CPC G10L 15/26
USPC 704/235

(57) ABSTRACT

Speech recognition techniques are employed in a variety of applications and services serving large numbers of users. As such, there is an increasing demand for speech recognition systems with enhanced performance. Specifically, enhanced performance in large vocabulary continuous speech recognition (LVCSR) systems is a market demand. Herein, convolutional neural networks are explored as an alternative speech recognition approach and different CNN architectures are tested. According to at least one example embodiment, a method and corresponding apparatus for performing speech recognition comprise employing a CNN with at least two convolutional layers and at least two fully-connected layers in speech recognition. Using the CNN a textual representation of input audio data may be provided based on output data by the CNN.

### BACKGROUND OF THE INVENTION

Automatic speech recognition is gaining attraction in a variety of applications including customer service applications, user-computer interaction applications, or the like. Different speech recognition techniques have been explored in the art. Some of the explored techniques have led to acceptable performance levels for such techniques to be employed in a variety of applications that are available to respective users.

### SUMMARY OF THE INVENTION

In speech recognition, specifically in large vocabulary continuous speech recognition (LVCSR), convolutional neural networks (CNNs) provide a valuable speech recognition technique. In terms of the architecture of CNNs, different parameters or characteristics affect speech recognition performance of CNNs. Herein, different architecture scenarios are described, and example CNN architecture embodiments that offer substantial performance improvement are determined.

According to at least one example embodiment, a method and corresponding apparatus for performing speech recognition comprise processing, by a cascade of at least two convolutional layers of a convolutional neural network, feature parameters extracted from audio data; processing, by a cascade of at least two fully-connected layers of the convolutional neural network, output of the cascade of the at least two consecutive convolutional layers; and providing a textual representation of the input audio data based on the output of a last layer of the at least two consecutive fully connected layers of the convolutional neural network.

According to at least one other example embodiment, at least one convolutional layer of the cascade of the at least two consecutive convolutional layers includes at least two hundred hidden units. The weighting coefficients employed in a convolutional layer, of the cascade of the at least two consecutive convolutional layers, are shared across the input space of the convolutional layer. However, the weighting coefficients employed in a first convolutional layer, of the cascade of the at least two consecutive convolutional layers, may be independent of weighting coefficients employed in a second convolutional layer, of the cascade of the at least two consecutive convolutional layers. Furthermore, each convolutional layer, of the cascade of the at least two consecutive convolutional layers, employ a pooling function of polling size fewer than four. The feature parameters extracted from the input audio data include vocal tract length normalization (VTLN) warpped Mel filter bank features with delta and double delta.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is block diagram illustrating a speech recognition system according to at least one example embodiment;

FIG. 2 is a block diagram illustrating the architecture of a convolutional layer, according to at least one example embodiment;

FIG. 3 illustrates a visualization of the distribution of spectral features corresponding to twelve speakers after being processed by two convolutional layers;

FIG. 4A-4D represent tables illustrating simulation results indicative of speech recognition performance of different CNN architectures;

FIG. 5A-5C represent tables illustrating simulation results indicative of speech recognition performance of CNN versus performance of other speech recognition techniques known in the art; and

FIG. 6 is a flow chart illustrating a method of performing speech recognition according to at least one example embodiment.

### DETAILED DESCRIPTION OF THE INVENTION

A description of example embodiments of the invention follows.

Advances achieved in speech recognition techniques, in general, and in large vocabulary continuous speech recognition (LVCSR), in particular, allow reliable transcription of continuous speech from a given speaker. LVSCR systems typically provide transcriptions of speech signals with relatively low error rates, which led to employment of such systems in a variety of services and applications. The use of LVSCR systems drives research towards further improvements in the performance of LVSCR techniques.

There are a number of challenges associated with developing successful techniques for LVCSR. First, when more data is used to train speech recognition models, gains observed with techniques on small vocabulary tasks diminish for LVCSR. Secondly, LVCSR tasks are more challenging and real-world in nature compared to many small vocabulary tasks in terms of vocabulary, noise disturbances, speaker variations, etc. Specifically, speech signals typically exhibit spectral correlations indicative of similarities between respective lexical content, and spectral variations due to speaker variations, channel variation, etc. According to at least one example embodiment, a Convolutional Neural Network (CNN) architecture is employed in LVCSR and provides a framework modeling spectral correlations and reducing spectral variations associated with speech signals.

Convolutional Neural Networks (CNNs) are a special type of multi-layer neural networks. Specifically, a CNN includes at least one convolutional layer, whose architecture, as discussed below, is different from that of a fully-connected layer of a conventional neural network. The CNN may also include one or more fully-connected layers sequentially following the at least one convolutional layer. Recently, Deep Belief Networks (DBNs), another type of neural networks, were shown to achieve substantial success in handling large vocabulary continuous speech recognition (LVCSR) tasks. In particular, DBNs's performance shows significant gains over state-of-the-art Gaussian Mixture Model/Hidden Markov Model (GMM/HMM) systems on a wide variety of small and large vocabulary speech recognition tasks. However, the architecture of DBNs is not typically designed to model translational variance within speech signals associated with variation in speaking styles, communication channels, or the like. As such, various speaker adaptation techniques are typically applied when using DBNs to reduce feature variation. While DBNs of large size may capture translational invariance, training such large networks involves relatively high computational complexity. CNNs, however, capture translational invariance with far fewer parameters by replicating weights across time and frequency. Furthermore, DBNs ignore input topology as the input may be presented in any order without affecting the performance of the network. However, spectral representations of a speech signal have strong correlations. CNNs and convolutional layers in particular provide an appropriate framework for modeling local correlations. Given the complexity and the spectral features exhibited by speech signals, the architecture of CNN employed plays a significant role in enhancing modeling of spectral correlations and providing speech recognition performance that is less susceptible to spectral variations.

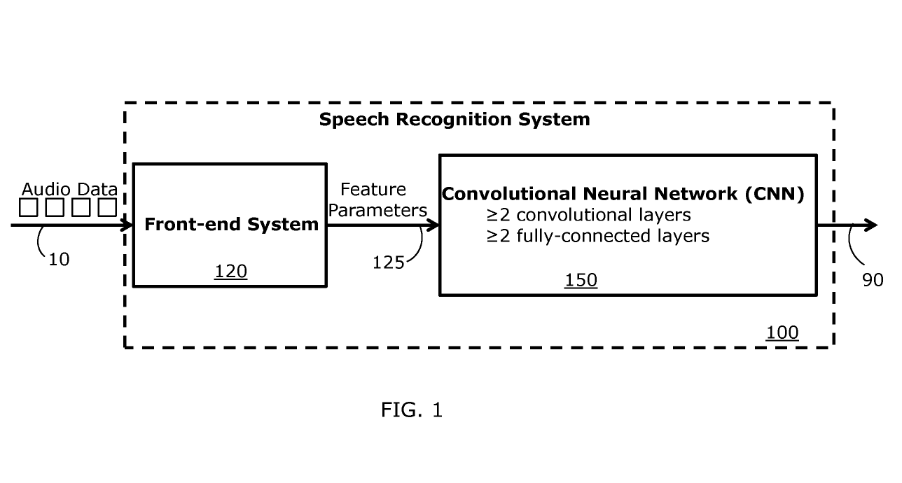

FIG. 1 is block diagram illustrating a speech recognition system 100 according to at least one example embodiment. The speech recognition system 100 includes a front-end system 120 and a CNN 150. The CNN 150 includes at least two convolutional layers and at least two fully-connected layers. Employing multiple-fully connected layers results in better performance in speaker adaptation and discrimination between phones. Input audio data 10 is fed to the front-end system 120. The front-end system 120 extracts spectral features 125 from the input audio data 10 and provides the extracted spectral features 125 to the CNN 150. According to at least one example embodiment, the extracted spectral features 125 exhibit local correlation in time and frequency. The CNN 150 uses the extracted features 125 as input to provide a textual representation 90 of the input audio data 10.

According to at least one example embodiment, the at least two convolutional layers of the CNN 150 are configured to model spectral and temporal variation of the extracted spectral features 125, and the fully-connected layers are configured to perform classifications of outputs from a last convolutional layer in the sequence of the at least two convolutional layers.

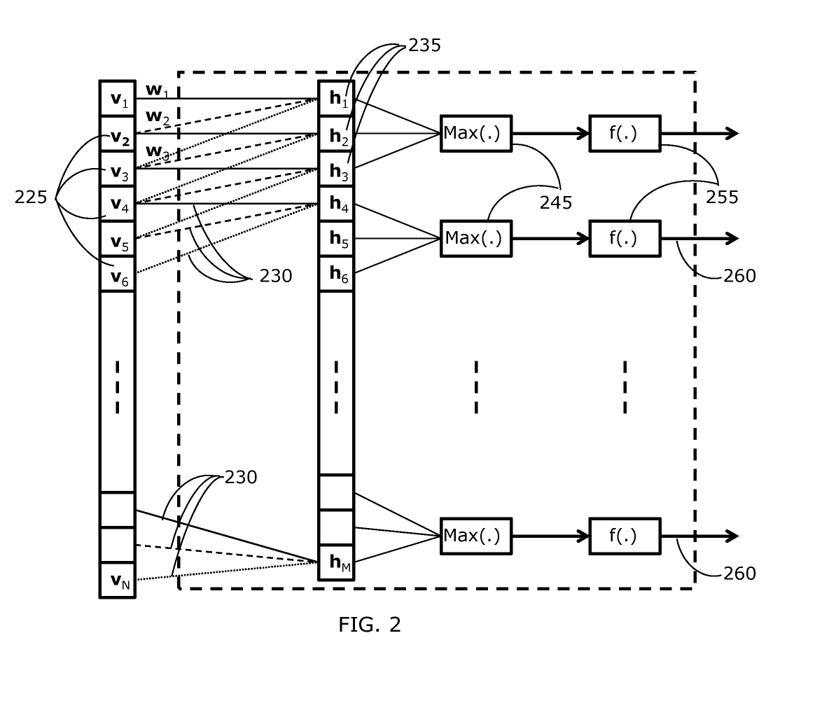

FIG. 2 is a block diagram illustrating the architecture of a convolutional layer 200 according to at least one example embodiment. An input vector V of input values v₁, v₂, . . . , v_{N} 225 is fed to the convolutional layer. According to at least one example embodiment, the input values 225 may represent the extracted spectral features 125 or output values of a previous convolutional layer. In a fully-connected layer, each hidden activation is computed by multiplying the entire input vector V by corresponding weights in that layer. However, in the CNN 150, local subsets of the input values are convolved with respective weights. According to an example embodiment, the same weights are used across each convolutional layer of the at least two convolutional layers. For example, in the architecture shown in FIG. 2, each convolutional hidden unit 235 is computed by multiplying a subset of local input values, e.g., v₁, v₂, and v₃, with a set of weights equal in number to the number of input values in each subset. The weights w₁, w₂, and w₃ 230, in the architecture illustrated in FIG. 2, are shared across the entire input space of the respective convolutional layer. In other words, the weights w₁, w₂, and w₃ 230 may be viewed as tap weights of a filter used to filter the input vector V to compute the convolutional hidden units 235.

After computing the convolutional units 235, a pooling function 245 is applied to the convolutional units 235. In the example architecture of FIG. 2, each pooling function 245 selects the maximum value among values of a number of local hidden units. Specifically, each max-pooling unit or function receives operates on outputs from r, e.g., 3, convolutional hidden units 235, and outputs the maximum of the outputs from these units. The outputs of the max-pooling units 245 are then fed to activation-function units 255, where an activation function, e.g., sigmoid function, is applied to each output of the max-pooling units 245. The outputs 260 of the activation-function units 255 represent the outputs of the convolutional layer 200. The outputs 260, are then fed to another convolutional layer or a fully-connected layer of the CNN 150. According to at least one example embodiment, the at least two convolutional layers are the first at least two layers of the CNN 150. The same weights 230 are used across the frequency spectrum of each input vector V and across time, e.g., for different input vectors. Such replication of weights across time and frequency enables CNNs to capture translational invariance with far fewer parameters.

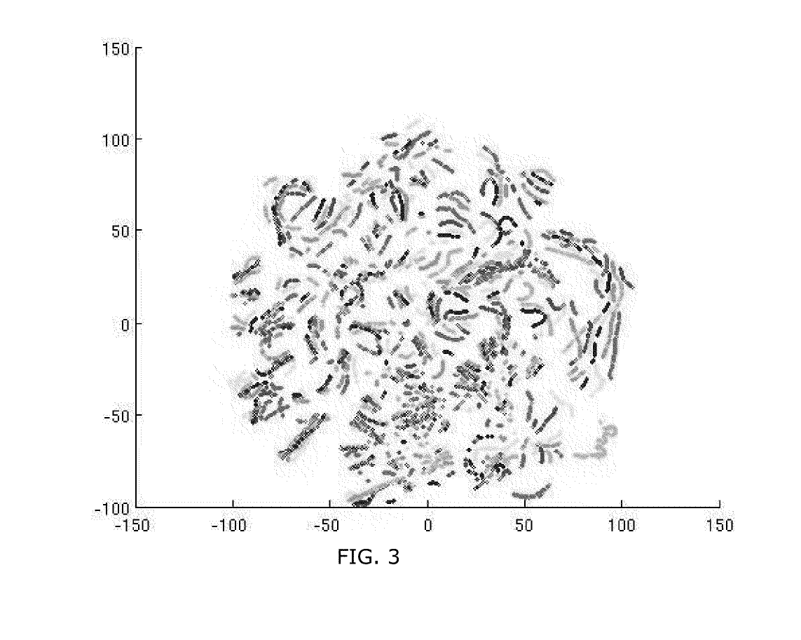

FIG. 3 illustrates a visualization of the distribution of spectral features corresponding to twelve speakers after being processed by two convolutional layers. Specifically, FIG. 3 is a t-distributed stochastic neighbor embedding (t-SNE) plot providing a 2-D representation of the distribution of outputs from the second convolutional layer in two convoltional layers of the CNN 150. The t-SNE is a visualization method typically used for visualizing a 2-D representation of variable with respective dimension higher than two. Specifically, t-SNE produces a 2-D plot in which variables, e.g., outputs 260 of activation-function units 255 or the hidden convolutional units 235 in the CNN 150, that are close together in the high dimensional space remain close together in the 2-D space. The t-SNE plot shown in FIG. 3 represents data produced based on the TIMIT corpus known in the art. The audio data of the Texas Instruments and Massachusetts Institute of Technology (TIMIT) corpus is used because it is a phonetically-rich and hand-labeled corpus, which makes data analysis easy. The t-SNE plot shown in FIG. 3 is produced based on SA utterances, e.g., two distinct utterances that are spoken by all 24 speakers in the core test set, from the TIMIT test core set. Specifically, the data represented in FIG. 3 illustrates the distribution of the outputs 260 of the activation-function units 255 corresponding to the same 12 SA utterances spoken by 24 different speakers.

In the t-SNE plot of FIG. 3, data points corresponding to different speakers are presented with different colors. The t-SNE plot shown in FIG. 3 clearly illustrates that phonemes from different speakers are aligned together. This indicates that the CNN 150 and the two convolutional layers in particular provide some sort of speaker adaptation. In essence, the two convolutional layers remove some of the variation from the input space and transform the features into a more invariant, canonical space. FIG. 3 shows that phonemes from different speakers are aligned together. This means that the convolutional layers are removing differences of phonemes from different speakers and mapping the same phoneme from different speakers into a canonical space. According to at least one example embodiment, employing two or more convolutional layers in the CNN 150 provides a framework for modeling spectral and temporal variations in speech signals corresponding to utterances and therefore allows reliable speech recognition. Also, employing two or more multiple-fully connected layers results in better performance in speaker adaptation and discrimination between phones.

In the following, results of a set of computer simulations testing the performance of CNNs in speech recognition are described and discussed. The acoustic models are trained using 50 hours of speech data of English Broadcast News recorded in 1996 and 1997 and known in the art as 50-hr English Broadcast News task. Results evaluating CNN performance are reported on the EARS dev04f set. Unless otherwise indicated, the CNNs employed in the simulations described below are trained with 40-dimensional log mel-filter bank coefficients, which exhibit local structure, to train the CNNs. In addition, the CNNs or deep belief networks (DBNs) employed in the simulations described below make use of 1,024 hidden units per each fully connected layer, and 512 output targets. During fine-tuning, after one pass through the data, loss is measured on a held-out set and the learning rate is annealed, or reduced, by a factor of 2 if the held-out loss has not improved sufficiently over the previous iteration. Training stops after we have annealed the step size 5 times. All DBNs and CNNs are trained with cross-entropy, and results are reported in a hybrid setup.

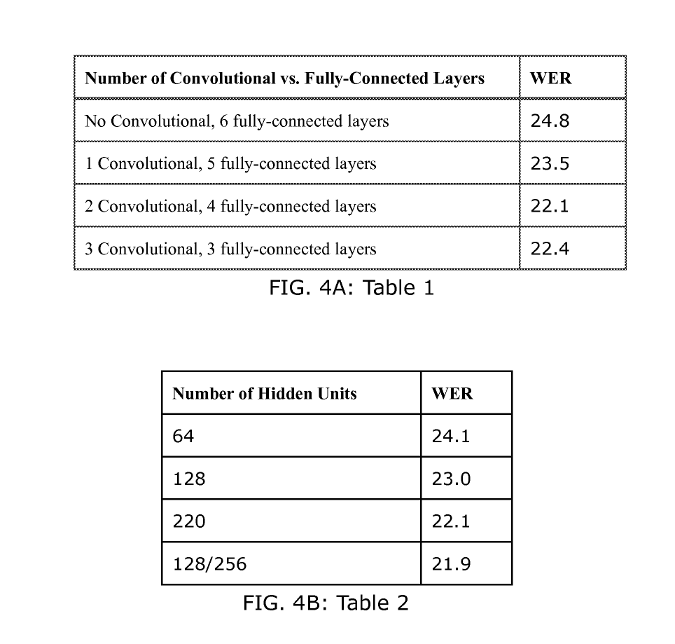

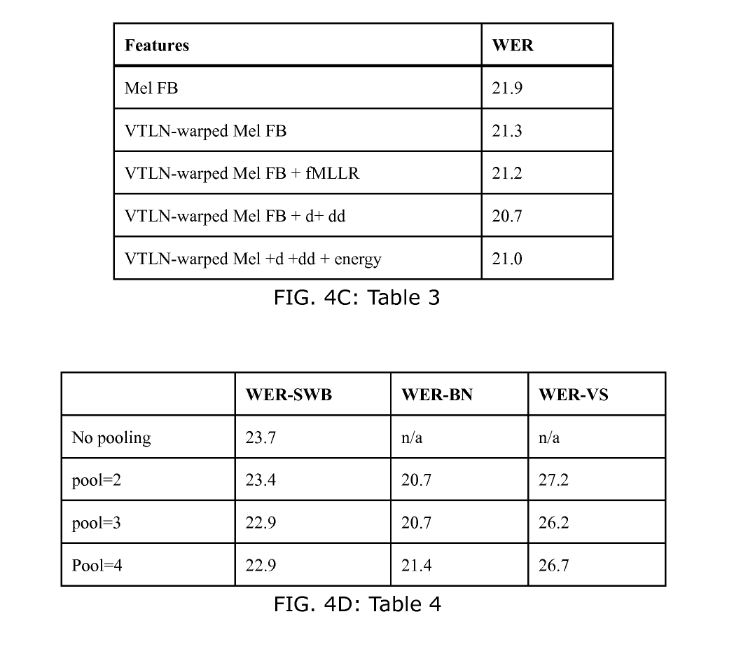

In FIG. 4A, Table 1 shows simulation results illustrating speech recognition performance of different networks associated with different numbers of convolutional layers and fully-connected layers. The speech recognition performance is expressed in terms of word error rate (WER). Four different networks are tested and the respective results are shown in the second to fifth row of the table in FIG. 4A. The total number of layers, i.e., the sum of the number of convoltional layers and fully-connected layers, is kept the same, e.g., equal to six, in the four tested networks. The four tested networks include a DBN, with six fully-connected layers and no convolutional layer, and three CNNs having, respectively, one, two, and three convolutional layer(s). The results shown in the table in FIG. 4A clearly show that (1) CNNs provide better performance than DBNs and that (2) relatively better performance, i.e., smaller WER, is achieved with the CNNs having, respectively, two and three convolutional layers. Specifically, a substantial reduction in WER is achieved with the tested CNN having two convolutional layers compared to the tested CNN having a single convolutional layer.

The local behavior of speech features in low frequency regions is different from the respective behavior in high frequency regions. In order to model the behavior of the spectral features both in low and high frequency regions, different filters or weights 230 may be applied across a single convolutional layer for low and high frequency components. However, such approach may limit the employment of multiple convolutional layers in the CNN 150 given that outputs from different filters may not be related as they may belong to different frequency bands. According to an example embodiment, applying the same weights 230 across the same convolutional layer, while employing a large number of convolutional hidden units 235, in each convolutional layer provides for reliable modeling of the behavior of the spectral features 125 at low and high frequency bands.

In FIG. 4B, Table 2 shows WER results for different CNNs associated with different numbers of hidden units per convolutional layer. The total number of parameters in the network is kept constant for all simulation experiments described in Table 2. That is, if there are more hidden convolutional units 235 in the convolutional layers, fewer hidden units are employed in the fully-connected layers. The results in Table 2 clearly illustrate that as the number of hidden units per convolutional layer increases, the WER steadily decreases. Specifically, substantial decrease in WER is achieved as the number of hidden units per convolutional layer increases up to 220. In the simulations associated with Table 2, the values tested for the number of hidden units per convolutional layer include 64, 128, and 220 hidden units. In the last simulation shown in Table 2, the first convolutional layer has 128 hidden convolutional units 235 and the second convolutional layer has 256 convolutional hidden units 235. The number of hidden units in the fully-connected layers, for all simulations shown in Table 2, is equal to 1,024. By increasing the number of hidden units in the convolutional layers, the respective CNN is configured to model the behavior of the spectral features 125 at different frequency bands.

In FIG. 4C, Table 3 shows simulation results where different spectral features 125 are employed as input to the same CNN. In the simulations shown in Table 3, the CNN 150 includes two convolutional layers with 128 convolutional hidden units 235 in the first convolutional layer and 256 in the second convolutional layer. CNNs typically provide better performance with features that exhibit local correlation than features that do not. As such, Linear Discriminant Analysis (LDA) features, which are commonly used in speech processing but are know to remove locality in frequency, are not tested in the simulations considered in Table 3. The spectral features tested in the simulations indicated in Table 3 include Mel filter-bank (Mel FB) features, which exhibit local correlation in time and frequency. Further transformations applied to Mel FB features are also explored. For example, vocal tract length normalization (VTLN) warping is employed to map features into a canonical space and reduce inter-speaker variability. Feature-space maximum likelihood regression (fMLLR), which provides compensation for channel and speaker variations, is also employed to test its effect on speech recognition performance. Also, delta and double-delta (d+dd) cepstral coefficients are appended to VTLN-warped Mel FB features since delta and double delta (d+dd) cepstarl features typically dynamic information to static features and therefore they introduce temporal dependencies. Energy features are also considered. The results in Table 3 indicate using VTLN-warping to help map features into a canonical space results in performance improvements. The use of fMLLR does not lead to significant improvement as the CNN 150 may already provide speaker-adaption especially when employing VTLN-warped features. The use of delta and double-delta (d+dd) to capture further time dynamic information in the features clearly provides improvement in the performance of the CNN 150. However, using energy-based features does not provide improvements in speech recognition performance. According to the results shown in Table 3, the smallest WER is achieved when employing VTLN-warped Mel FB+d+dd features.

In FIG. 4D, Table 4 shows simulation results indicating the effect of pooling, in the convolutional layers of the CNN 150, on speech recognition performance. Pooling in CNNs may help to reduce spectral variance in the input features 125. According to at least one example embodiment, pooling is performed after on outputs of the convolutional units 235 as indicated in FIG. 2. Pooling may be dependent on the input sampling rate and speaking style associated with the speech data used. In the simulations indicated in Table 4, different pooling sizes are tested for three different 50 hr tasks corpora having different characteristics, namely 8 kHz speech—Switchboard Telephone Conversations (SWB), 16 kHz speech—English Broadcast News (BN), and 16 kHz speech—Voice Search (VS). The results in Table 4 clearly indicate that pooling results in substantial reduction in WER. For the BN and VS corpora, no simulation was performed where no pooling is applied given that the use of pooling is shown to be beneficial based on the results associated with SWB corpus. In the case where no pooling is applied, outputs from the convolutional units 235 may be fed directly to the activation-function units 255, e.g., the convolutional layers do not include the pooling units 245, or pooling may be implemented with size equal to 1. The pooling size refers to the number of inputs fed to the pooling units 245. Based on the results shown in Table 4, the lowest WER is achieved, for all data corpora used, when the pooling size is equal to three.

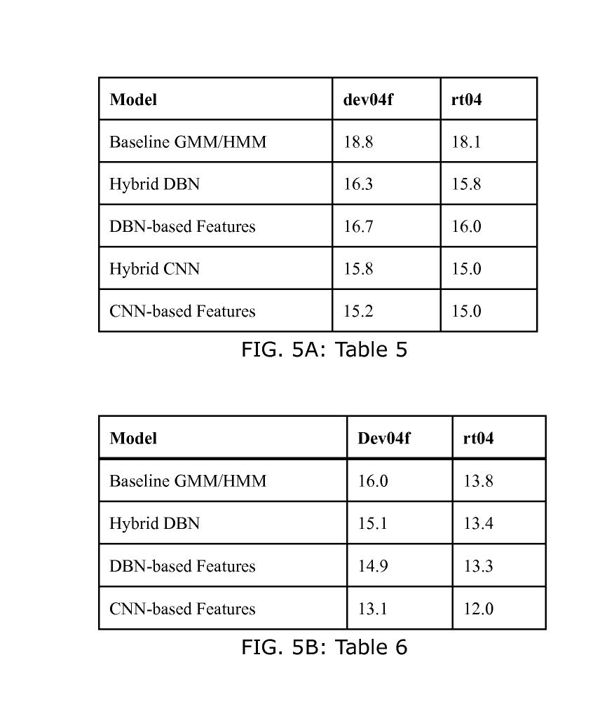

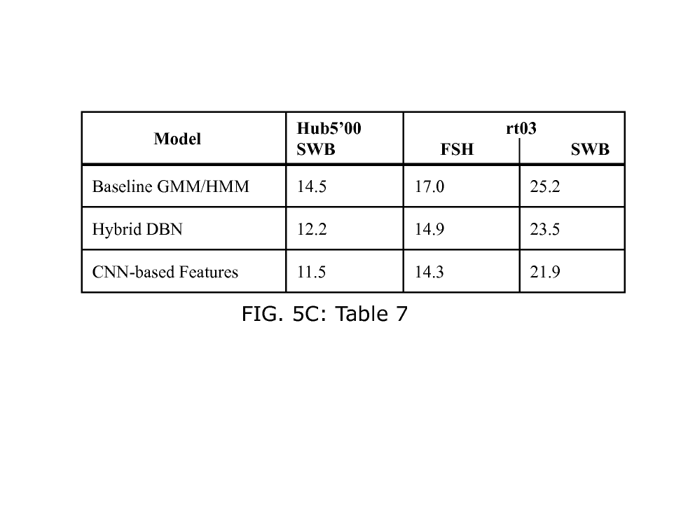

FIG. 5A show Table 5 with simulation results for CNN architecture in both hybrid and neural network-based features systems as well as other speech recognition techniques typically used for LVCSR tasks. In a hybrid system, the probabilities in the neural network are used as the output distribution of hidden Markov model (HMM) states. In CNN-based features, features are derived from a neural network, and modeled by a Gaussian Mixture Model (GMM). In CNN-based features the GMM is used as the output distribution of HMM states. The other speech recognition techniques include Gaussian mixture models (GMM), or hidden Markov models (HMM), hybrid DBN and DBN-based features system known in the art. The simulations are conducted on the same 50-hour English Broadcast News task used and respective results are reported for both the EARS dev04f and rt04 data sets used for development and testing, respectively.

In training the GMM system, the features used are 13-dimensional Mel frequency cepstral coefficients (MFCC) with speaker-based mean, variance, and vocal tract length normalization (VTLN). Temporal context is included by splicing 9 successive frames of MFCC features into super-vectors, then projecting to 40 dimensions using LDA. That is, LDA is a dimensionality reduction technique that will take a (13×9)-dimensional vector and generate a respective 40-dimensional vector. Then, a set of feature-space speaker-adapted (FSA) features are created using feature-space maximum likelihood linear regression (fMLLR). Finally, feature-space discriminative training and model-space discriminative training are applied using the boosted maximum mutual information (BMMI) criterion. At test time, unsupervised adaptation using regression tree MLLR is performed. The GMMs use 2,220 quinphone states and 30K diagonal Gaussian covariance matrix.

The hybrid DBN is trained using FSA features as input, with a context of 9 frames around the current frame. A 5-layer DBN with 1,024 hidden units per layer and a sixth softmax layer with 2,220 output targets is. All DBNs are pre-trained generatively. During fine-tuning, the hybrid DBN is first trained using the cross-entropy objective function, followed by Hessian-free sequence-training The DBN-based feature system is also trained with the same architecture, but uses 512 output targets. A principal component analysis (PCA) is applied on top of the DBN before the softmax layer to reduce the dimensionality from 512 to 40. Using these DBN-based features, maximum-likelihood GMM training is applied, followed by feature and model-space discriminative training using the BMMI criterion and a maximum likelihood linear regression (MLLR) at test time. The GMM acoustic model has the same number of states and Gaussian mixtures as the baseline GMM system. The hybrid CNN and CNN-based features systems are trained using VTLN warped Mel-FB with delta+double-delta (+d+dd) features. The number of parameters of the CNN used matches that of the DBN, with the hybrid system having 2,220 output targets and the feature-based system having 512 output targets. No pre-training is performed, only cross-entropy and sequence-training are applied for the hybrid and CNN-based features systems.

In FIG. 5A, Table 5 shows the performance of the CNN-based features and hybrid CNN systems as well as the performances of the hybrid DBN, the DBN-based features system and the GMM/HMM system. The results indicate that the hybrid DBN offers about 13% relative improvement over the GMM/HMM. According to the same results, the CNN systems, i.e., hybrid or CNN-based feature systems, provide even better performance than the DBN systems, i.e., hybrid or DBN-based feature systems. The CNN hybrid offers about 3% to 5% performance improvement over that of hybrid DBN and the CNN-based features system offers about 5% to 6% performance improvement over that of hybrid DBN. In the results of Table 5, the CNN-based features system provided the best performance over Given that we obtain the best performance when considering both the EARS dev04f and rt04 sets of data.

In FIG. 5B, Table 6 shows simulation results indicative of the performance of the CNN-based features system based on the 400 hours of English Broadcast News corpus. Table 5 also shows the performance results for the GMM/HMM system, hybrid DBN, and DBN-based features system. In the simulations indicated in Table 5, the development, e.g., determining model parameters such as the number of convolutional layers and number of hidden units, etc., is performed based on the DARPA EARS dev04f set and the testing is performed based on the DARPA EARS rt04 evaluation set. The acoustic features are 19-dimensional perceptual linear predictive (PLP) features with speaker-based mean, variance, and VTLN, followed by an LDA and then fMLLR. The GMMs are then feature and model-space discriminatively trained using the BMMI criterion. At test time, unsupervised adaptation using regression tree MLLR is performed. The GMMs use 5,999 quinphone states and 150K diagonal-covariance Gaussians. The hybrid DBN system employs the same fMLLR features and 5,999 quinphone states with a 9-frame context (±4) around the current frame. The hybrid DBN has five hidden layers each containing 1,024 sigmoidal units. The DBN-based features system is trained with 512 output targets. The DBN training begins with greedy, layerwise, generative pre-training followed by cross-entropy training and then sequence training.

The CNN-based features system is trained with VTLN-warped Mel-FB with delta+double-delta features. The CNN-based features system includes two convolutional layers and four fully-connected layers. The last fully connected layer is a softmax layer having 512 output targets. The three other fully connected layers have each 1,024 hidden units. The first and second convolutional layers have, respectively, 128 and 256 hidden units. The number of parameters of the CNN-based features system matches that of the hybrid DBN and DBN-based features systems. That is, the size of weight matrix for each network is the same. No pre-training is performed, only cross-entropy and sequence-training are applied. After 40-dimensional features are extracted with PCA, maximum-likelihood GMM training is applied followed by discriminative training using the BMMI criterion and an MLLR at test time.

Table 6 shows the performance of the CNN-based features system compared to the GMM/HMM system, hybrid DBN, and DBN-based features system. The CNN-based features system offers between 13% to 18% relative improvement over the GMM/HMM system, and between 10% to 12% relative improvement over the DBN-based features system. Such results confirm that CNNs with at least two convolutional layers provider better speech recognition performance over DBN systems.

In FIG. 5C, Table 7 shows simulation results for based on 300 hours of conversational American English telephony data from the Switchboard corpus known in the art. In the simulations, development is performed based on the Hub5'00 data set and testing is performed based on the rt03 data set. Performance results are reported, in Table 7, separately on the Switchboard (SWB) and Fisher (FSH) portions of the data set rt03. The GMM system is trained using the same methods applied in the simulations, described in Table 6, for Broadcast News, namely using speaker-adaptation with VTLN and fMLLR, followed by feature and model-space discriminative training with the BMMI criterion. Results are reported after MLLR. The GMMs use 8,260 quinphone states and 372K Gaussians. The hybrid DBN system uses the same fMLLR features and 8,260 states, with an 11-frame context (±5) around the current frame. The hybrid DBN has six hidden layers each containing 2,048 sigmoidal units. The DBN hybrid system is pre-trained and then cross-entropy and sequence training are applied. The CNN-based features system is trained with VTLN-warped Mel-FB features. The CNN-based features system has two convolutional layers, each having 424 hidden units, and three fully-connected layers, each having 2,048 hidden units. The softmax layer has 512 output targets. The number of parameters of the CNN-based features system matches that of the DBN systems. No pre-training is performed, only cross-entropy and sequence-training are performed for the CNN-based features system. After 40-dimensional features are extracted with PCA, GMM ML training is done followed by discriminative training, and then MLLR at test time.

Table 7 shows the performance of the CNN-based features compared to the hybrid DBN system and the GMM/HMM system. Note that we only results for a Hybrid DBN are shown in Table 7. In fact, when using speaker-independent LDA features, the results for SWB indicated that the hybrid DBN and the DBN-based features system had the same performance on Hub5'00. In addition, the results in Table 6 show that the hybrid and DBN-based features systems have similar performance. As such, only the Hybrid DBN model is considered in the simulations indicated in Table 7. According to the results in Table 7, the CNN-based features system offers 13% to 33% relative improvement over the GMM/HMM system. The CNN-based features system also provides 4% to 7% relative improvement over the hybrid DBN model according to the results in Table 7. These results confirm that across a wide variety of LVCSR tasks, CNNs with at least two convolutional layers provide better performance than DBNs.

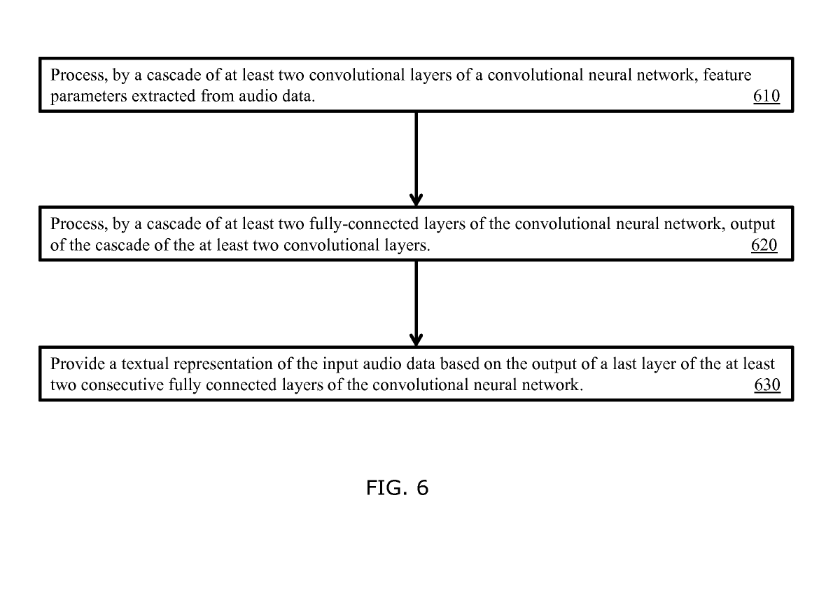

FIG. 6 is a flow chart illustrating a method of performing speech recognition according to at least one example embodiment. At block 610, feature parameters extracted from audio dated are processed by a cascade of at least two convolutional layers of a convolutional neural network. At block 620, output values of the cascade of the at least two convolutional layers are processed by a cascade of at least two fully-connected layers of the convolutional neural network. At block 630, a textual representation of the input audio data is provided based on the output of a last layer of the at least two consecutive fully connected layers of the convolutional neural network.

It should be understood that the example embodiments described above may be implemented in many different ways. In some instances, the various methods and machines described herein may each be implemented by a physical, virtual or hybrid general purpose or application specific computer having a central processor, memory, disk or other mass storage, communication interface(s), input/output (I/O) device(s), and other peripherals. The general purpose or application specific computer is transformed into the machines that execute the methods described above, for example, by loading software instructions into a data processor, and then causing execution of the instructions to carry out the functions described, herein.

As is known in the art, such a computer may contain a system bus, where a bus is a set of hardware lines used for data transfer among the components of a computer or processing system. The bus or busses are essentially shared conduit(s) that connect different elements of the computer system, e.g., processor, disk storage, memory, input/output ports, network ports, etc., that enables the transfer of information between the elements. One or more central processor units are attached to the system bus and provide for the execution of computer instructions. Also attached to the system bus are typically I/O device interfaces for connecting various input and output devices, e.g., keyboard, mouse, displays, printers, speakers, etc., to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

In certain embodiments, the procedures, devices, and processes described herein constitute a computer program product, including a computer readable medium, e.g., a removable storage medium such as one or more DVD-ROM's, CD-ROM's, diskettes, tapes, etc., that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transitory machine-readable medium, which may be read and executed by one or more processors. A non-transient machine-readable medium may include any mechanism for storing or transmitting information in a form readable by a machine, e.g., a computing device. For example, a non-transient machine-readable medium may include read only memory (ROM); random access memory (RAM); magnetic disk storage media; optical storage media; flash memory devices; and others.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It also should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A method of performing speech recognition, the method comprising:
processing, by a cascade of at least two convolutional layers of a convolutional neural network, feature parameters extracted from audio data;
processing, by a cascade of at least two fully connected layers of the convolutional neural network, output of the cascade of the at least two consecutive convolutional layers; and
providing a textual representation of the input audio data based on the output of a last layer of the at least two consecutive fully connected layers of the convolutional neural network.

2. A method according to claim 1, wherein at least one convolutional layer of the cascade of the at least two consecutive convolutional layers includes at least two hundred hidden units.

3. A method according to claim 1, wherein weighting coefficients employed in a convolutional layer, of the cascade of the at least two consecutive convolutional layers, are shared across the input space of the convolutional layer.

4. A method according to claim 1, wherein weighting coefficients employed in a first convolutional layer, of the cascade of the at least two consecutive convolutional layers, are independent of weighting coefficients employed in a second convolutional layer, of the cascade of the at least two consecutive convolutional layers.

5. A method according to claim 1, wherein the feature parameters extracted from the input audio data include vocal tract length normalization (VTLN) wrapped Mel filter bank features with delta and double delta.

6. A method according to claim 1, wherein each convolutional layer, of the cascade of the at least two consecutive convolutional layers, employ a pooling function of polling size less than four.

7. An apparatus for performing speech recognition, the apparatus comprising:
at least one processor; and
at least one memory with computer code instructions stored thereon, the at least one processor and the at least one memory with computer code instructions being configured to cause the apparatus to:
process, by a cascade of at least two convolutional layers of a convolutional neural network, feature parameters extracted from audio data;
process, by a cascade of at least two fully connected layers of the convolutional neural network, output of the cascade of the at least two consecutive convolutional layers; and
provide a textual representation of the input audio data based on the output of a last layer of the at least two consecutive fully connected layers of the convolutional neural network.

8. An apparatus according to claim 7, wherein at least one convolutional layer of the cascade of the at least two consecutive convolutional layers includes at least two hundred hidden units.

9. An apparatus according to claim 7, wherein weighting coefficients employed in a convolutional layer, of the cascade of the at least two consecutive convolutional layers, are shared across the input space of the convolutional layer.

10. An apparatus according to claim 7, wherein weighting coefficients employed in a first convolutional layer, of the cascade of the at least two consecutive convolutional layers, are independent of weighting coefficients employed in a second convolutional layer, of the cascade of the at least two consecutive convolutional layers.

11. An apparatus according to claim 7, wherein the feature parameters extracted from the input audio data include vocal tract length normalization (VTLN) wrapped Mel filter bank features with delta and double delta.

12. An apparatus according to claim 7, wherein each convolutional layer, of the cascade of the at least two consecutive convolutional layers, employ a pooling function of polling size less than four.

13. A non-transitory computer-readable medium storing thereon computer software instructions for performing speech recognition, the computer software instructions when executed by a processor cause an apparatus to perform:
processing, by a cascade of at least two convolutional layers of a convolutional neural network, feature parameters extracted from audio data;
processing, by a cascade of at least two fully connected layers of the convolutional neural network, output of the cascade of the at least two consecutive convolutional layers; and
providing a textual representation of the input audio data based on the output of a last layer of the at least two consecutive fully connected layers of the convolutional neural network.

14. A non-transitory computer-readable medium according to claim 13, wherein at least one convolutional layer of the cascade of the at least two consecutive convolutional layers includes at least two hundred hidden units.

15. A non-transitory computer-readable medium according to claim 13, wherein weighting coefficients employed in a convolutional layer, of the cascade of the at least two consecutive convolutional layers, are shared across the input space of the convolutional layer.

16. A non-transitory computer-readable medium according to claim 13, wherein weighting coefficients employed in a first convolutional layer, of the cascade of the at least two consecutive convolutional layers, are independent of weighting coefficients employed in a second convolutional layer, of the cascade of the at least two consecutive convolutional layers.

17. A non-transitory computer-readable medium according to claim 13, wherein the feature parameters extracted from the input audio data include vocal tract length normalization (VTLN) wrapped Mel filter bank features with delta and double delta.

18. A non-transitory computer-readable medium according to claim 13, wherein each convolutional layer, of the cascade of the at least two consecutive convolutional layers, employ a pooling function of polling size less than four.
